(19) United States
(12) Patent Application Publication
(10) Pub. No.: US 2026/0087520 A1
(43) Pub. Date: Mar. 26, 2026

(54) COMPUTER METHOD AND BUSINESS METHOD FOR DISTRIBUTION OF PHYSICAL ADVERTISING

(71) Applicant: GIORGI PIPIA, Luxembourg (LU)

(72) Inventor: GIORGI PIPIA, Luxembourg (LU)

(21) Appl. No.: 19/339,405

(22) Filed: Sep. 25, 2025

Related U.S. Application Data
(60) Provisional application No. 63/699,394, filed on Sep. 26, 2024.

(51) Int. Cl. G06Q 30/0251; G06K 19/06; G06Q 30/0241; G06Q 30/0242

(52) U.S. Cl. CPC G06Q 30/0257; G06Q 30/0242; G06Q 30/0277; G06K 19/06037

(57) ABSTRACT

A computer method and business method provides sponsored advertising to consumers at a venue, receives inquiries from consumers via scanning of a response bar code symbol at a linked web address, and displays online content. An event organizer or the venue is paid for distributing a free product bearing the advertising from payment received from an advertiser. The agent computer may maintain a database of responses and display response analytics to the advertiser.

### CROSS-REFERENCE TO RELATED APPLICATIONS

The present application claims priority benefit from U.S. Provisional Patent Application Ser. No. 63/699,394 (docket number 3098-001-02), entitled “COMPUTER METHOD AND BUSINESS METHOD FOR DISTRIBUTION OF PHYSICAL ADVERTISING,”filed Sep. 26, 2024.

The foregoing application, to the extent not inconsistent with the disclosure herein, is incorporated by reference.

### SUMMARY

According to an embodiment, a computer method for delivering advertising and receiving direct responses includes receiving, into a server computer of an agent, an agreement for placement, at a venue, of advertising physically associated with a product by an advertiser; with the server computer or a operatively coupled computer, receiving or generating digital artwork for the advertising physically associated with a product, the digital artwork including advertising indicia; with the server computer or an agent-controlled computer, inserting a response bar code symbol into, over, or adjacent to the advertising indicia. The server computer may cause distribution, at no cost to any consumer, of the product or packaged product carrying advertising indicia corresponding to the digital artwork and the response bar code symbol to consumers at the venue. The server computer may receive inquiries from a responsive consumer responsive to the advertising, via the consumer scanning of the response bar code symbol, at a web address corresponding to the response link, and cause display of online content to the responsive consumer. The server computer may capture the consumer response in an agent database and display response analytics to the advertiser at a web page controlled by the agent via an advertiser computer.

According to an embodiment, a business method for delivering advertising and receiving responses to the advertising includes receiving an agreement for placement, at a venue, of advertising physically associated with a product by an advertiser; receiving or generating digital artwork for the advertising physically associated with the product, the digital artwork including advertising indicia; and inserting a response bar code symbol into, over, or adjacent to the advertising indicia. The business method may include causing distribution, at no cost to any consumer, product carrying the advertising indicia and response bar code symbol and/or carried by the packaging carrying the product to consumers at the venue, receiving an inquiry from a consumer responsive to the advertising via the consumer scanning of the response bar code symbol into a server computer at a web address corresponding to the response link; and causing display of online content to the responsive consumer on an agent web page accessed from the response link.

### BRIEF DESCRIPTION OF THE DRAWINGS

FIGS. 1A-1D are views of examples of advertising indicia and response bar code symbols disposed on filled water packaging, according to an embodiment.

FIGS. 2A and 2B present a diagram illustrating computer and business methods including communications between parties, according to embodiments.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

As used herein, the term server computer refers to a computer controlled by an agent responsible for taking an order from an advertiser and for causing no-cost product carrying advertising to be distributed at a venue, and optionally, at an event associated with the venue. It is recognized that the term server computer may refer to a single Internet-accessible computer or may refer to a plurality of linked computers configured to cooperate for performing various functions including some or all of a receipt of advertising orders from the advertiser, negotiation for placement of product packaged with the advertising with a venue or event organizer, receipt of inquiries at a network address linked by a response bar code symbol on the product packaging, presentation of analytics to the advertiser, and disbursement of negotiated fees to the venue or event organizer.

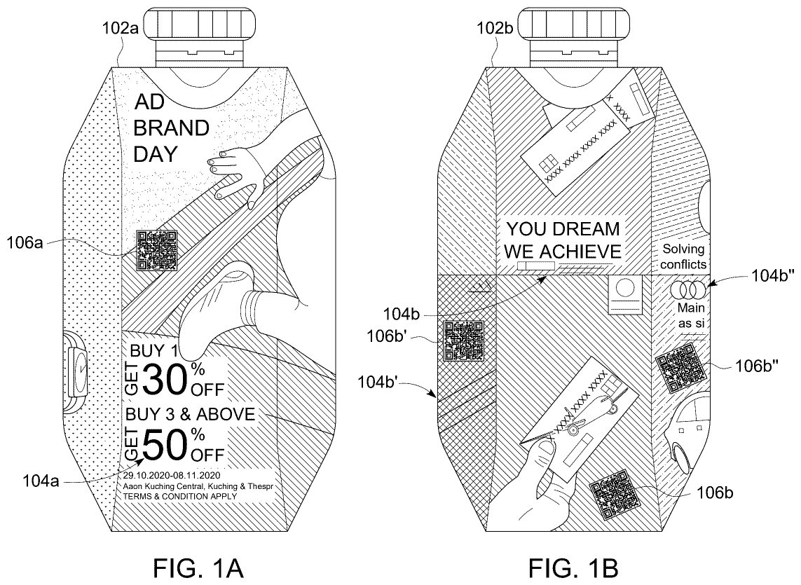

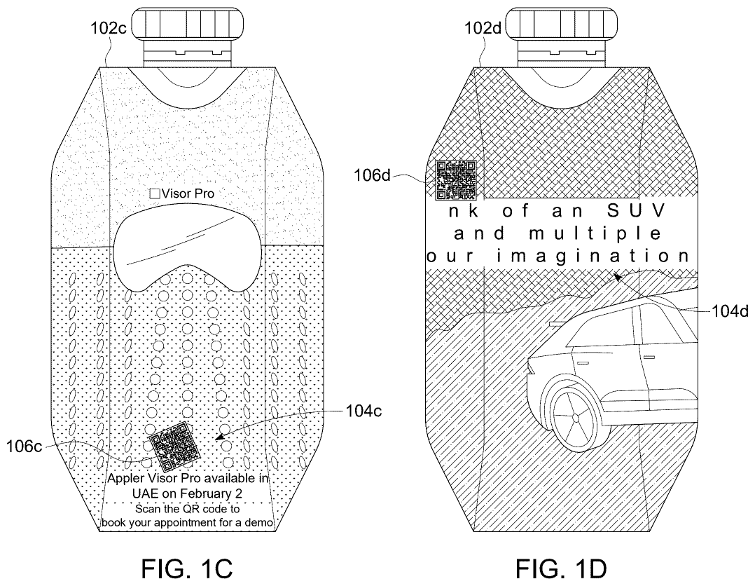

FIGS. 1A-1D are views of examples of advertising indicia and response bar code symbols disposed on respective filled water packaging 102a, 102b, 102c, 102d, according to embodiments. Each example includes respective advertising indicia 104a, 104b, 104c, and 104d. Each advertising indicia is accompanied by a respective response bar code symbol 106a, 106b, 106c, 106d configured to link to a respective Internet-addressable content relevant to the printed advertising indicia.

In some embodiments, plural advertising indicia and respective corresponding bar code symbols may be provided on different portions of the surface of the product or packaging. For example, referring to FIG. 1B, the product 102b may include a first advertising indicia 104b on one side of the package 102b, and second and third advertising indicia 104b′, 104b″ on other sides of the packaging. In an embodiment, each advertising indicia 104b, 104b′, 104b″ includes an adjacent or superimposed corresponding response bar code symbol 106b, 106b′, 106b″ configured to link to content relevant to the respective advertising indicia 104b, 104b′, 104b″ relevant thereto.

In another embodiment, a single response bar code symbol, not shown, may be provide, the single bar code symbol being configured to link to a landing page, the landing page including actuatable controls for linking to a particular one of the advertising indicia 104b, 104b′, 104b″.

Still referring especially to FIG. 1B as depicted, the edges or borders between adjacent advertising indicia regions may coincide with “sides” or “folds” in the packaging 102a, 102b, 102c, 102d. Alternatively or additionally, borders between adjacent advertising regions may be placed at locations other than folds in the packaging. In some embodiments, a single business entity may sponsor plural advertising intended to convey a message about a respective plurality of products or services. In such cases, individual advertising indicia may overlap or otherwise impinge on neighboring indicia. For example, the business entity may include an identity message disposed across plural advertising indicia.

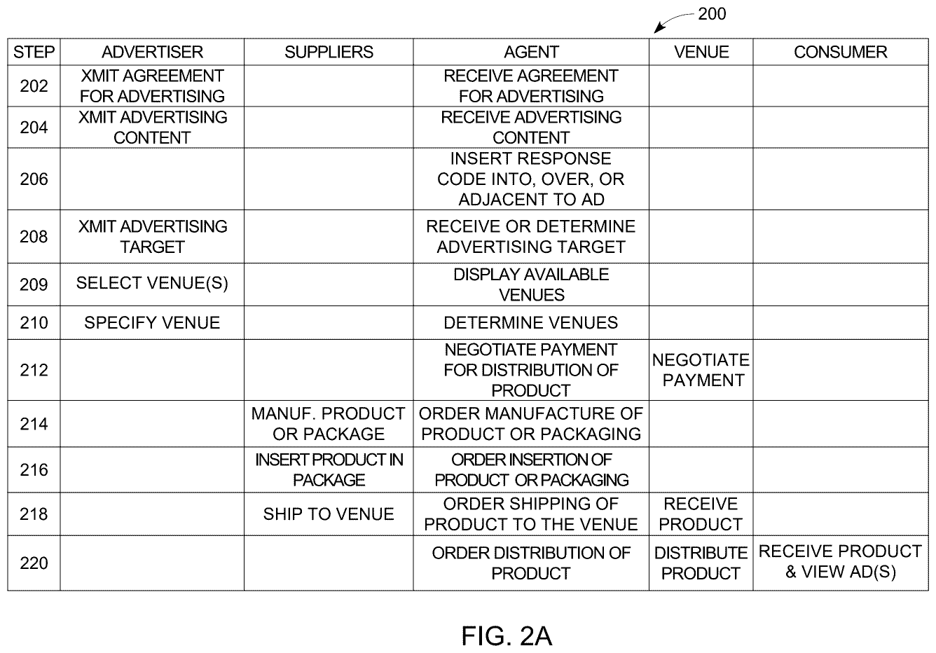

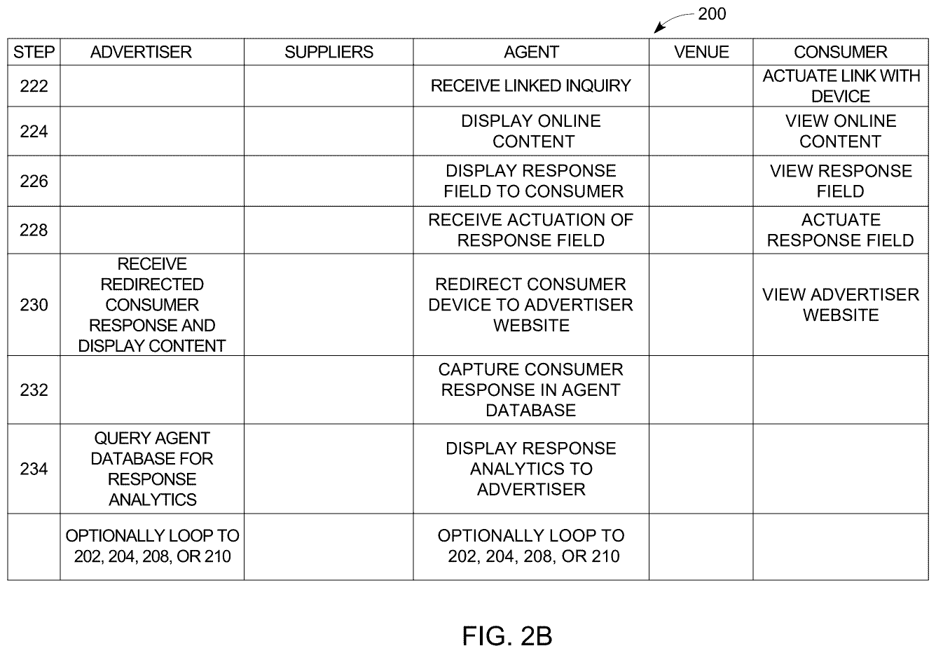

FIG. 2 is a diagram illustrating a business method and a computer method 200 including communications between parties, according to embodiments. With reference to FIG. 2, a method 200 for delivering advertising and receiving responses to the advertising includes, in step 202, an agent receiving an agreement for placement, at a venue to consumers at the venue, of advertising physically associated with a product by an advertiser. For example, such advertising may be formed on packaging with which the product is provided. Step 204 includes receiving or generating digital artwork for the advertising physically associated with a product, the digital artwork including advertising indicia. In step 206, a response bar code symbol is inserted into, superimposed over, or disposed adjacent to the advertising indicia in the digital artwork.

According to an embodiment, receiving the agreement for placement of the advertising physically associated with a product by the advertiser, in step 204, includes receiving identification of at least the venue by the advertiser. In an embodiment, receiving identification of a venue includes identification of an event.

In other embodiments, receiving the agreement for placement of the advertising physically associated with a product by the advertiser, in step 204, includes receiving identification of a target consumer for the advertising. In such embodiments, the method 200 may include, in step 210, determining an identification of one or more venues for distribution of, the one or more venues corresponding to attendance by the target consumer. In other words, the agent may manage at least a portion of an advertising campaign. Additionally or alternatively, apparatuses and functions described herein may be provided by the agent as a platform for use by the advertiser. It is contemplated that a venue and/or plurality of vendors may be recruited and a deal negotiated with ahead of a time when an advertiser operates an interface to create a campaign. In this case, the agent's server computer may provide a listing of available venues, as indicated in step 209, from which the advertiser, in step 210, selects a set or subset according to a best match to access to a target consumer demographic or cartographic (e.g., geofenced) characteristic.

In an embodiment, the method 200 includes step 208, including determining the target consumer for the on-product advertising. The target consumer may, for example, meet one or more demographic criterion. In another example, the target consumer by be defined by a geographic location.

Receiving or creating the digital artwork in step 204 may include receiving the digital artwork from the advertiser or an advertiser-controlled computer into the server computer. In step 206, the agent may cause the response bar code symbol to be inserted into the digital artwork by the server computer or an agent-controlled computer operatively coupled to the server computer. In an embodiment, data encoded by the response bar code symbol is controlled by the agent. Optionally, another form of linking may be included with the product and/or package. For example, a human-readable alphanumeric field may operate as a linking symbol or an RF tag may contain information for viewing and accessing the information may be reported to the agent without direct access by the consumer to an agent website. Optionally, the advertising indicia and/or a linking bar code symbol may be accompanied by a referral code offering a discount to a consumer if they respond via the linking and/or by a deadline. In an embodiment, the linked content is provisioned by the agent.

The response bar code symbol may include a 2-dimensional matrix symbol such as a QR code. The response bar code symbol may be unique with respect to a particular advertising campaign or a particular advertising indicia.

As used herein, the terms advertising indicia and indicia refer to printed advertising artwork disposed on a product or package of a product that is freely distributed to consumers at a venue.

Proceeding to step 220, the agent causes distribution, at no cost to any consumer, product 102a, 102b, 102c, 102d with corresponding digital artwork disposed on the product or carried by product packaging, the product or packaging bearing the digital artwork including the response bar code symbol and the advertising indicia to consumers at the venue. The consumer correspondingly receives the product and the packaging, and may consume or otherwise use the product while viewing the advertising indicia. The consumer may scan the response bar code symbol to view linked content on a consumer's portable electronic device.

In step 222, the agent receives an inquiry from the consumer responsive to the advertising, via the consumer scanning of the response bar code symbol, into a server computer at a web address corresponding to the response link. In step 224, causes display, with the server computer, of the linked content to the consumer on the consumer's portable electronic device.

According to an embodiment, the method 200 includes, in step 226, displaying a response field to the responsive consumer in the linked content. The consumer may actuate the response field (e.g., an HTML control) and, in step 228, the agent receives actuation of the response field. Upon receiving actuation, the agent, in step 230 may redirect the responsive consumer's inquiry to a website controlled by the advertiser. In another embodiment, upon receiving actuation in step 228, the agent, in step 230, may redirect the responsive consumer's inquiry to a website controlled by the agent on behalf of the advertiser.

The agent may, in step 232, capture the consumer response in an agent database. The advertiser may access an agent-controlled website corresponding to the campaign, upon which, in step 234, a server computer controlled by the agent displays response analytics to the advertiser. Responsive to the analytics, the advertiser may cause the method 200 to loop back to the beginning, optionally with a modified product, packaging, advertising indicia, response bar code symbol, quantity, venue, event, and/or other parameters.

According to an embodiment, the method 200 includes, in step 212, negotiating payment to the venue or to an event organizer for the distribution of the product to the consumers at the venue. In an embodiment, step 212 includes negotiating payment to the venue or to the event organizer consists essentially of negotiating payment to the venue. In such case, step 238, described below, consists essentially of paying the venue.

The method 200 may include, in step 236, receiving agent payment from the advertiser and, in step 238, paying the venue or the event organizer the negotiated payment from a portion of received agent payment.

As shown in FIG. 1, the product for distribution includes bottled water. The packaging may include low carbon cost cellulosic packaging. For example, the packaging may include a carton, such as “Tetra Pak”, available from Tetra Laval of Pully, Switzerland.

At least one of the advertising physically associated with a product and the displayed content carries information about plastic waste avoided by the low carbon cost cellulosic packaging.

Negotiating the payment for distribution of the product, in step 212, may further include transmitting, to the venue or an organizer of one or more in-person events, an offer of payment for distribution of the product carrying the advertising and receiving an acceptance of the offer of payment from the venue or the organizer. As used herein, the term payment is intended to comprehend a negotiated price and/or a profit-sharing arrangement between the agent and a vendor.

The method 200 may include managing the manufacture and/or printing of the product or packaging for the product. That is, the method 200 may include, in step 214, causing manufacturing the packaging including the advertising physically associated with a product and the response bar code symbol, in step 216, causing filling the packaging with the product in the packaging to form a packaged product, and, in step 218, causing shipping the product or packaged product to the venue.

According to an embodiment, a computer method for delivering advertising and receiving direct responses includes, in step 202, receiving, into a server computer of an agent, an agreement for placement, at an event venue, of advertising physically associated with a product by an advertiser and, in step 204, with the server computer or an agent-controlled linked computer, receiving or generating digital artwork for the advertising physically associated with a product, the digital artwork including advertising indicia. Step 206 includes, with the server computer or an agent-controlled computer operatively coupled to the server computer, inserting a response bar code symbol into the advertising indicia. Proceeding to step 220 the server computer causes distribution, at no cost to any consumer, product carried by the packaging carrying the digital artwork and the response bar code symbol to consumers at the venue. The method 200 may further include, in step 222, receiving inquiries from the consumers responsive to the advertising, via the consumer scanning of the response bar code symbol, into the server computer at a web address corresponding to the response link. In step 224, the server computer may causing display of online content to each responsive consumer at the response link. The server computer may, in step 232, capture the consumer response in an agent database. As shown in step 334, the server computer may display response analytics derived from the agent database to the advertiser via a web page controlled by the agent.

The server computer or an agent-controlled computer networked to the server computer may encode the response bar code symbol according to a link schema controlled by the agent. The response bar code symbol may include a 2-dimensional matrix bar code symbol such as a QR code.

Receiving the agreement for placement of the advertising physically associated with the product by the advertiser and/or into an agent server computer may include receiving identification of at least the venue and/or event at the venue by the advertiser in an online form provided by the agent. In an embodiment, receiving the agreement for placement of the advertising physically associated with the product by the advertiser includes receiving identification of a target consumer for the advertising in an online form displayed by the server computer. According to an embodiment, the server computer runs code, in step 210, to determine, an identification of one or more in-person events and/or venues, the one or more events and/or venues corresponding to attendance by the target consumer;

According to an embodiment, the server computer may, in step 212, automatically or with agent personnel input, negotiate payment to the venue or to an event organizer for the distribution of the product to the consumers of the event. For example, step 312 may further include transmitting, to a counterparty computer corresponding to the venue or an organizer of the one or more events, an offer of payment for distribution of the product carrying the advertising and receiving acceptance of the offer of payment from the venue or the organizer computer.

Optionally, the server computer may include an accounting module configured to, in step 226, receive agent payment from the advertiser and, in step 338, pay the venue or the event organizer the negotiated payment from a portion of received agent payment.

Optionally, the server computer may include a manufacturing module configured to communicate with counterparty computer or computers data selected to, in step 214, cause manufacture the packaging including the advertising physically associated with a product and the response bar code symbol; in step 216, cause filling the packaging with the product in the packaging to form a packaged product. Optionally, the server computer may include a logistics module configured to, in step 218, cause shipping the product or packaged product to the venue.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer method for delivering advertising and receiving direct responses, comprising:
receiving, into a server computer of an agent, an agreement for placement, at an event venue, of advertising physically associated with a product by an advertiser;
with the server computer or an operatively coupled agent-controlled computer, receiving or generating digital artwork for the advertising physically associated with a product, the digital artwork including advertising indicia;
with the server computer or an agent-controlled operatively coupled computer, inserting a response bar code symbol into the advertising indicia;
with the server computer, causing distribution, at no cost to any consumer, product carried by the packaging carrying the digital artwork and the response bar code symbol to consumers at the venue;
with the server computer, receiving inquiries from the consumers responsive to the advertising, via the consumer scanning of the response bar code symbol, into the server computer at a web address corresponding to the response link;
with the server computer causing display of at least additional advertising to each responsive consumer at the response link;
with the server computer, capturing the consumer response in an agent database; and
with the server computer, displaying response analytics to the advertiser via a secure web page controlled by the agent.

2. The computer method for delivering advertising and receiving responses to the advertising of claim 1, wherein data encoded by the response bar code symbol is controlled by the agent server computer.

3. The computer method for delivering advertising and receiving responses to the advertising of claim 2, wherein the response bar code symbol includes a 2-dimensional matrix symbol.

4. The computer method for delivering advertising and receiving responses to the advertising of claim 3, wherein the response bar code symbol includes a QR code.

5. The computer method for delivering advertising and receiving responses to the advertising of claim 1, wherein receiving the agreement for placement of the advertising physically associated with a product by the advertiser includes receiving identification of at least the event or the venue by the advertiser.

6. The computer method for delivering advertising and receiving responses to the advertising of claim 1, wherein receiving the agreement for placement of the advertising physically associated with a product by the advertiser includes receiving identification of a target consumer for the advertising; and
further comprising:
determining, with the server computer, an identification of one or more events at a venue, the one or more events corresponding to attendance by the target consumer;

7. The computer method for delivering advertising and receiving responses to the advertising of claim 1, further comprising:
determining, with the server computer, a target consumer for the on-product advertising;

8. The computer method for delivering advertising and receiving responses to the advertising of claim 1, further comprising:
negotiating payment to the venue or to an event organizer for the distribution of the product to the consumers at the venue;
receiving agent payment from the advertiser; and
paying the venue or the event organizer the negotiated payment from a portion of received agent payment.

9. The computer method for delivering advertising and receiving responses to the advertising of claim 8, wherein negotiation payment to the venue or to the event organizer comprises negotiating payment to the venue; and
wherein paying the venue or the event organizer comprises paying the venue.

10. The computer method for delivering advertising and receiving responses to the advertising of claim 1, wherein the product comprises bottled water; and
wherein the packaging comprises low carbon cost cellulosic packaging.

11. The computer method for delivering advertising and receiving responses to the advertising of claim 10, wherein at least one of the advertising physically associated with a product and the displayed additional advertising carries information about plastic waste avoided by the low carbon cost cellulosic packaging.

12. The computer method for delivering advertising and receiving responses to the advertising of claim 1, further comprising:
transmitting, to the venue or an organizer of the one or more events, an offer of payment for distribution of the product carrying the advertising; and
receiving an acceptance of the offer of payment from the venue or the organizer.

13. The computer method for delivering advertising and receiving responses to the advertising of claim 1, further comprising:
causing manufacture the packaging including the advertising physically associated with a product and the response bar code symbol;
causing filling the packaging with the product in the packaging to form a packaged product; and
causing shipping the packaged product to the venue.

14. A business method for delivering advertising and receiving responses to the advertising, comprising:
receiving an agreement for placement, at an event venue, of advertising physically associated with a product by an advertiser;
receiving or generating digital artwork for the advertising physically associated with a product, the digital artwork including advertising indicia;
inserting a response bar code symbol into the advertising indicia, over the advertising indicia, or adjacent to the advertising indicia, the response bar code symbol carrying data for directing an consumer electronic device to a response link;
causing distribution, at no cost to any consumer, product carried by the packaging carrying the digital artwork and the response bar code symbol to consumers at the venue;
receiving an inquiry from an consumer responsive to the advertising, via the consumer scanning of the response bar code symbol, into a server computer at a web address corresponding to the response link; and
causing display, with the server computer via the consumer electronic device, of online content to the consumer at the response link.

15. The business method for delivering advertising and receiving responses to the advertising of claim, further comprising:
displaying a response field to the consumer;
receiving actuation of the response field; and
redirecting the consumer's electronic device to the advertiser's website

16. The business method for delivering advertising and receiving responses to the advertising of claim 14, further comprising:
capturing the consumer response in an agent database; and
displaying response analytics to the advertiser via a secure web page controlled by the agent.

17. The business method for delivering advertising and receiving responses to the advertising of claim 14, wherein receiving or creating the digital artwork includes receiving the digital artwork into the server computer; and
wherein the response bar code symbol is inserted into the digital artwork by the server computer.

18. The business method for delivering advertising and receiving responses to the advertising of claim 14, wherein data encoded by the response bar code symbol is controlled by the agent.

19. The business method for delivering advertising and receiving responses to the advertising of claim 18, wherein the response bar code symbol includes a 2-dimensional matrix symbol.

20. The business method for delivering advertising and receiving responses to the advertising of claim 19, wherein the response bar code symbol includes a QR code.

21. The business method for delivering advertising and receiving responses to the advertising of claim 14, wherein the response bar code symbol is unique with respect to a particular advertising campaign or a particular advertising indicia.

22. The business method for delivering advertising and receiving responses to the advertising of claim 14, wherein receiving the agreement for placement of the advertising physically associated with a product by the advertiser includes receiving identification of at least the event or the venue by the advertiser.

23. The business method for delivering advertising and receiving responses to the advertising of claim 14, wherein receiving the agreement for placement of the advertising physically associated with a product by the advertiser includes receiving identification of a target consumer for the advertising; and
further comprising:
determining an identification of one or more events at a venue, the one or more events corresponding to attendance by the target consumer.

24. The business method for delivering advertising and receiving responses to the advertising of claim 14, further comprising:
determining a target consumer for the on-product advertising.

25. The business method for delivering advertising and receiving responses to the advertising of claim 14, further comprising:
negotiating payment to the venue or to an event organizer for the distribution of the product to the consumers at the venue;
receiving agent payment from the advertiser; and
paying the venue or the event organizer the negotiated payment from a portion of received agent payment.

26. The business method for delivering advertising and receiving responses to the advertising of claim 25, wherein negotiating payment to the venue or to the event organizer consists essentially of negotiating payment to the venue; and
wherein paying the venue or the event organizer consists essentially of paying the venue.

27. The business method for delivering advertising and receiving responses to the advertising of claim 14, wherein the product comprises bottled water; and
wherein the packaging comprises low carbon cost cellulosic packaging.

28. The business method for delivering advertising and receiving responses to the advertising of claim 27, wherein at least one of the advertising physically associated with a product and the displayed additional advertising carries information about plastic waste avoided by the low carbon cost cellulosic packaging.

29. The business method for delivering advertising and receiving responses to the advertising of claim 14, further comprising:
transmitting, to the venue or an organizer of the one or more (in-person) events, an offer of payment for distribution of the product carrying the advertising; and
receiving an acceptance of the offer of payment from the venue or the organizer.

30. The business method for delivering advertising and receiving responses to the advertising of claim 14, further comprising:
causing manufacturing the product and/or product packaging including the advertising physically associated with a product and the response bar code symbol;
causing filling the packaging with the product in the packaging to form a packaged product; and
causing shipping the product or packaged product to the venue.
